(19) United States
(12) Patent Application Publication
(10) Pub. No.: US 2026/0024049 A1
(43) Pub. Date: Jan. 22, 2026

(54) COMMON COLLABORATIVE MODELLING SERVICE FOR CLOUD APPLICATIONS

(71) Applicant: SAP SE, Walldorf (DE)

(72) Inventors: Deepak G DESHPANDE, Bengaluru (IN); Prajwal GONSALVES, Bangalore (IN); Abhay Kumar SHARMA, Bengalore (IN)

(21) Appl. No.: 18/775,513

(22) Filed: Jul. 17, 2024

(51) Int. Cl. G06Q 10/101; G06Q 10/067

(52) U.S. Cl. CPC G06Q 10/101; G06Q 10/067

(57) ABSTRACT

A system associated with a common collaborative modeling framework in a cloud computing environment may include a common collaborative modeling data store containing information about a plurality of collaborative modeling applications (with each collaborative modeling application being associated with an integration process). A common collaborative server may receive a first registration request, including a first user identifier and an application identifier, from a first user device. The common collaborative server may also receive a second registration request, including a second user identifier and the application identifier, from a second user device. Based on the received first and second registration requests, information in the common collaborative modeling data store may be updated. A model change message from the first user device may then be received, and, responsive to the received model change message, the common collaborative server may push a model change message to the second user device.

### BACKGROUND

An enterprise may implement processes. For example, a company may implement business processes to handle sales orders, item deliveries, inventory monitoring, etc. Moreover, the processes may be automated using integration models. There are many software applications and products that are based on such models where a developer creates a sequence of events or processes and the appropriate sequence of flow steps for a scenario. Most software modeling tools only let a single user access the tool and provide for single user-based development. In some cases, however, more than one developer may want to work on the same modeling process project simultaneously, but such an ability is not generally available with integration modeling tools.

It would therefore be desirable to provide a common collaborative server within a modeling framework in a secure, automatic, and efficient manner.

### SUMMARY

According to some embodiments, methods and systems associated with a common collaborative modeling framework may include a common collaborative modeling data store containing information about a plurality of collaborative modeling applications (with each collaborative modeling application being associated with an integration process). A common collaborative server may receive a first registration request, including a first user identifier and an application identifier, from a first user device. The common collaborative server may also receive a second registration request, including a second user identifier and the application identifier, from a second user device. Based on the received first and second registration requests, information in the common collaborative modeling data store may be updated. A model change message from the first user device may then be received, and, responsive to the received model change message, the common collaborative server may push a model change message to the second user device.

Some embodiments comprise: means for receiving, at a computer processor of a common collaborative data store, a first registration request, including a first user identifier and an application identifier, from a first user device; means for receiving a second registration request, including a second user identifier and the application identifier, from a second user device; based on the received first and second registration requests, means for updating information in a common collaborative modeling data store, wherein the common collaborative modeling data store contains information about a plurality of collaborative modeling applications, each collaborative modeling application being associated with an integration process; means for receiving a model change message from the first user device; and, responsive to the received model change message, means for pushing a model change message to the second user device.

Some technical advantages of some embodiments disclosed herein are improved systems and methods to provide a common collaborative server within a modeling framework in a secure, automatic, and efficient manner.

### BRIEF DESCRIPTION OF THE DRAWINGS

FIG. 1 is a high-level common collaborative modeling framework architecture in accordance with some embodiments.

FIG. 2 is a method according to some embodiments.

FIG. 3 is an integration flow modeler display in accordance with some embodiments.

FIG. 4 is a registration process according to some embodiments.

FIG. 5 is a change and update process in accordance with some embodiments.

FIG. 6 is a draft save process according to some embodiments.

FIG. 7 is a draft save acknowledgement process in accordance with some embodiments.

FIG. 8 is a deregistration process according to some embodiments.

FIG. 9 is a more detailed method from a modeling client’s point-of-view in accordance with some embodiments.

FIG. 10 is an apparatus or platform according to some embodiments.

FIG. 11 is a portion of a registration database in accordance with some embodiments.

FIG. 12 illustrates a tablet computer model flow display according to some embodiments.

FIG. 13 is a common collaborative server operator or administrator display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

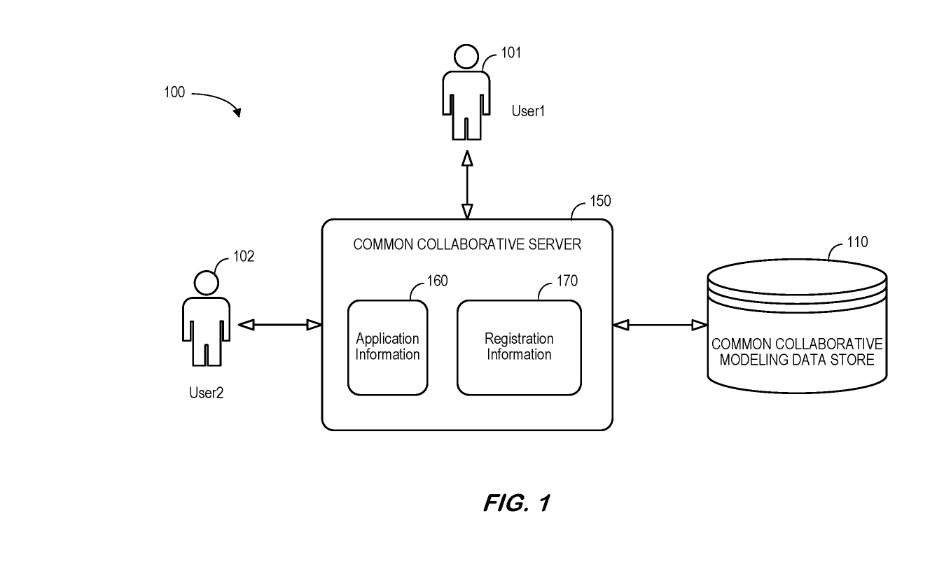

FIG. 1 is a high-level block diagram of one example of a common collaborative modeling framework 100 architecture according to some embodiments. In particular, a common collaborative server 150 may access information about a plurality of collaborative modeling applications (e.g., each collaborative modeling application being associated with an integration process) from a common collaborative modeling data store 110. The common collaborative server 150 may then use application information 160 and registration information 170 to create or modify a collaborative modeling experience for users (e.g., client devices for user1 101 and user2 102). According to some embodiments, a remote operator or administrator device may be used to configure or otherwise adjust the framework 100.

As used herein, devices, including those associated with the framework 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The common collaborative server 150 may store information into and/or retrieve information from various data stores (e.g., the common collaborative modeling data store 110), which may be locally stored or reside remote from the common collaborative server 150. Although a single common collaborative server 150 is shown in FIG. 1, any number of such devices may be included. Moreover, various devices described herein might be combined according to embodiments of the present invention. For example, in some embodiments, the common collaborative modeling data store 110 and the common collaborative server 150 might comprise a single apparatus. The framework 100 functions may be performed by a constellation of networked apparatuses, such as in a distributed processing or cloud-based architecture. In some cases, the common collaborative server 150 may process information associated with a number of different enterprises.

The enterprise may access the framework 100 via a remote device (e.g., a Personal Computer (“PC”), tablet, or smartphone) to view information about and/or manage operational information in accordance with any of the embodiments described herein. In some cases, an interactive Graphical User Interface (“GUI”) display may let an operator or administrator define and/or adjust certain parameters via a remote device (e.g., to specify a draft saving interval to be used for an enterprise computing environment infrastructure) and/or provide or receive automatically generated recommendations, alerts, summaries, or results associated with the framework 100.

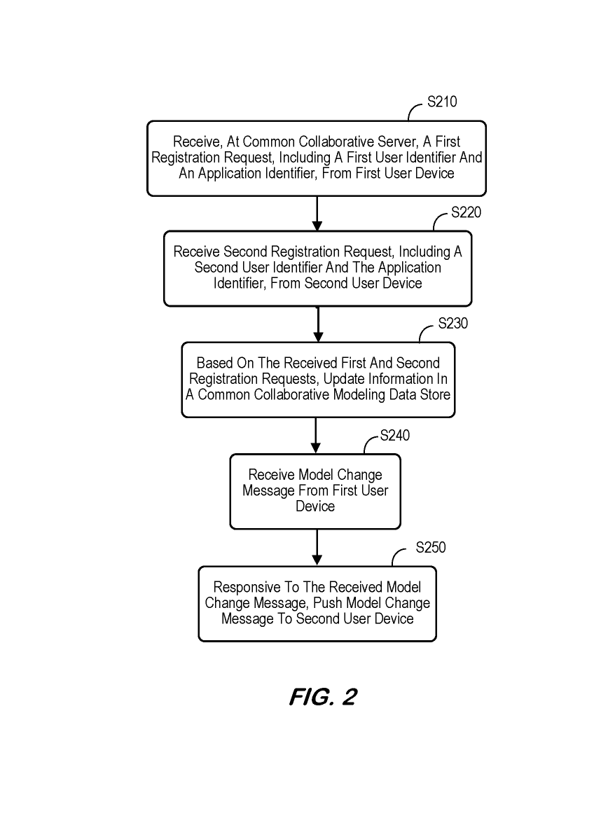

FIG. 2 is a method that might be performed by some or all of the elements of the framework 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a computer processor of a common collaborative server may receive a first registration request (including a first user identifier and an application identifier) from a first user device. According to some embodiments, the first registration request might further include an artifact identifier, an operation identifier, and a draft interval, etc. In some embodiments, the first registration request is received via a WebSocket. As used herein, the term “WebSocket” may refer to a computer communications protocol that provides a simultaneous two-way communication channel over a single Transmission Control Protocol (“TCP”) connection. The WebSocket protocol was standardized by the Internet Engineering Task Force (“IETF”) as Request For Comment (“RFC”) 6455 (2011). The WebSocket Application Programing Interface (“API”) may, for example, open a two-way interactive communication session between a user’s browser and a server letting the client send messages to the server and receive event-driven responses without needing to poll the server for a reply. In some embodiments, the common collaborative server is implemented in the cloud computing environment via a microservice architecture.

At S220, the system may receive a second registration request (including a second user identifier and the application identifier) from a second user device. Based on the received first and second registration requests, at S230 the system may update information in a common collaborative modeling data store. The common collaborative modeling data store may, for example, contain information about a plurality of collaborative modeling applications (each associated with an integration process).

At S240, the system may then receive a model change message from the first user device. The received model change message might, for example, include the first user identifier, a source location, an operation type, a model identifier, an application coordinate, etc. Responsive to the received model change message, at S250 the system may push a model change message to the second user device. In this way, a common collaborative modeling process between multiple users is enabled. Although two users are described herein for clarity, embodiments may enable a common collaborative modeling process for any number of users (e.g., hundreds of users).

In some embodiments, the common collaborative server is further to verify the model change request from the first user device. Moreover, in some embodiments the common collaborative server asks at least one user device to persist draft save information to a local database in accordance with the draft interval (and the at least one user device replies with an indication that the draft save information has been successfully persisted). In some embodiments, the common collaborative server is further to receive a deregistration request from the first user device (ending the collaborative modeling process).

In this way, collaborative modeling may reduce the time required for modeling and increase the productivity of model developers. Embodiments may also help product support colleagues make corrections to customer models in a simplified manner. Further, embodiments may help developers with different areas of expertise collaborate effectively for a common goal. Thus, a collaborative setup may be extremely beneficial for customers and a product support team. Embodiments described herein may provide a generic solution for collaborative modeling that various applications can easily adopt and apply. For example, a common collaborative modeling service for cloud applications might be implemented as a service that provides a framework for collaboration in modeling-based tools. The service might implement the registration of applications, registration of users, the distribution of a collaboration model payload, notifications to automatically save draft resources, data synchronization, the deregistering of users, the deregistering of applications, etc.

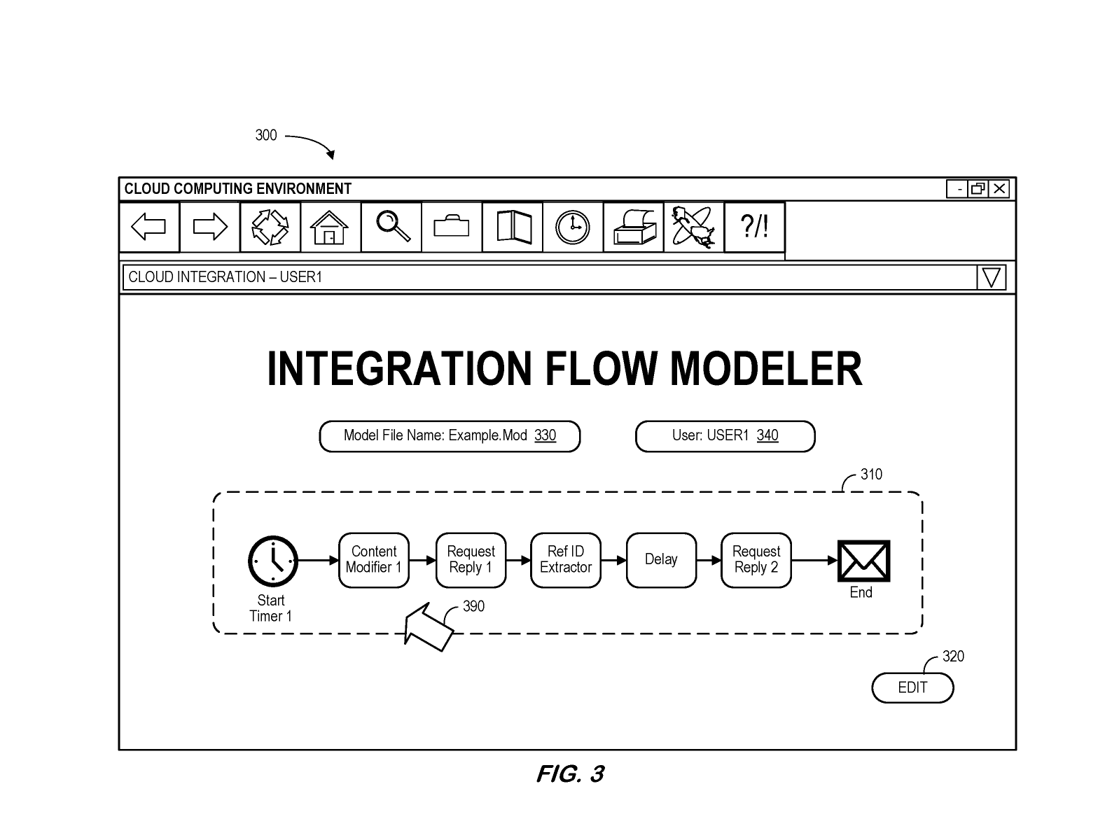

Consider FIG. 3 which is an integration flow modeler display 300 in accordance with some embodiments. A user might use the display 300 to create or modify a series of integration steps 310, such as via selection of an “Edit” icon 320. Moreover, multiple users might want to simultaneously work on a single model (e.g., a resource identified by a model file name 330). In this example “USER1” 340 is working with the display 300 while another user is working on the same model via another, similar display 300.

According to some embodiments, a common collaboration modeling service requires that applications register with the service using a specific unique identifier, a project specific unique identifier, and some metadata details. The collaborative modeling service may work with a payload that the registered applications provide called an OperationPayload. Every application sends this OperationPayload after the user makes a change in via the application. This payload from the application might, for example, contain the following details: a SourceLocation to define where the change was made when the modeling has multiple views; an OperationType to define what kind of operation is performed in the modeling editor; a ModelPayload containing details about the model such as the model identifier, diagram identifier, etc.; AdditionalProperties such as a map of String, Object that clients need to update their model in the application.

The collaborative modeling service distributes the OperationPayload to the clients who have registered with the service using the same application and artifact identifiers. Additionally, the collaborative modeling service will take make a persist call to the applications so as to save the data as a draft resource according to a timeout period (set during registrations) and handle reloading a modeling editor if the editor has missed some of the modeling updates. When the collaboration is complete, the respective clients can deregister their collaborative sessions.

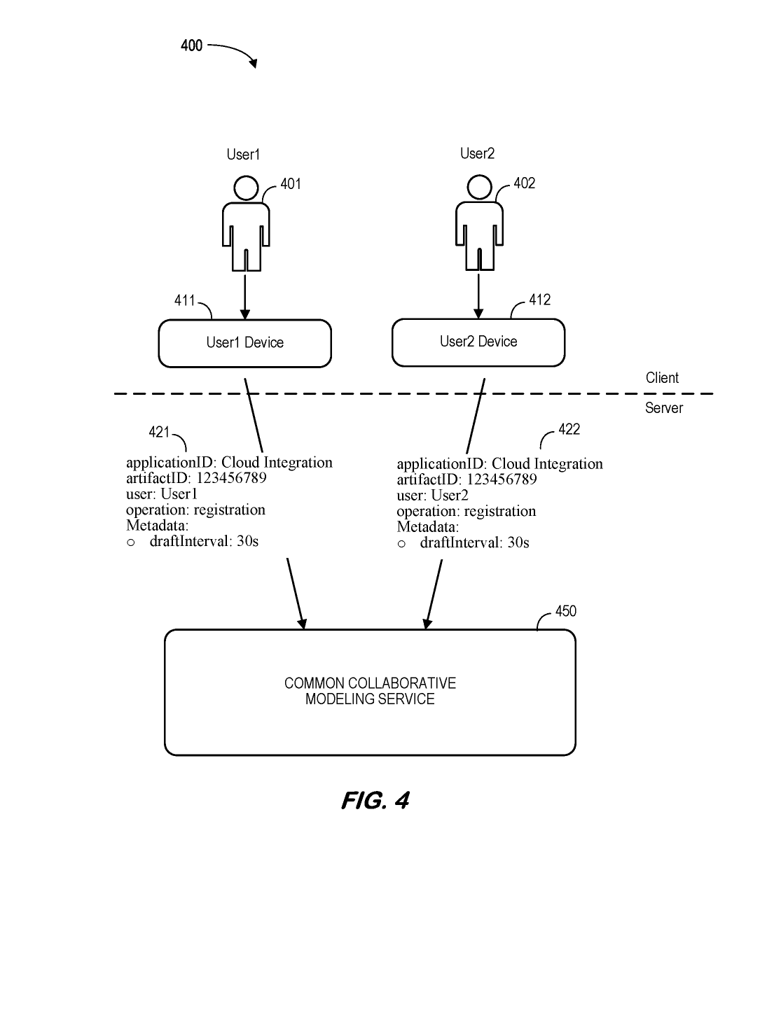

FIG. 4 is a registration process 400 according to some embodiments. In particular, USER1 401 works with a model on a USER1 device 411 while USER2 402 works with the same model on a USER2 device 412. The devices 411, 412 are clients of a common collaborative modeling service 450. That is multiple users 401, 402 want to work with an integration flow modeler collaboratively and the common collaborative modeling service 4550 is deployed as an application that will allow for this. Initially during registration USER1 and USER2 register with the common collaborative modeling service 450 providing details 421, 422 via WebSockets. The details 421, 422 might include, for example, an application identifier, an artifact identifier, a user identifier, an operation indication (e.g., “registration”), a draft interval (e.g., 30 seconds), etc.

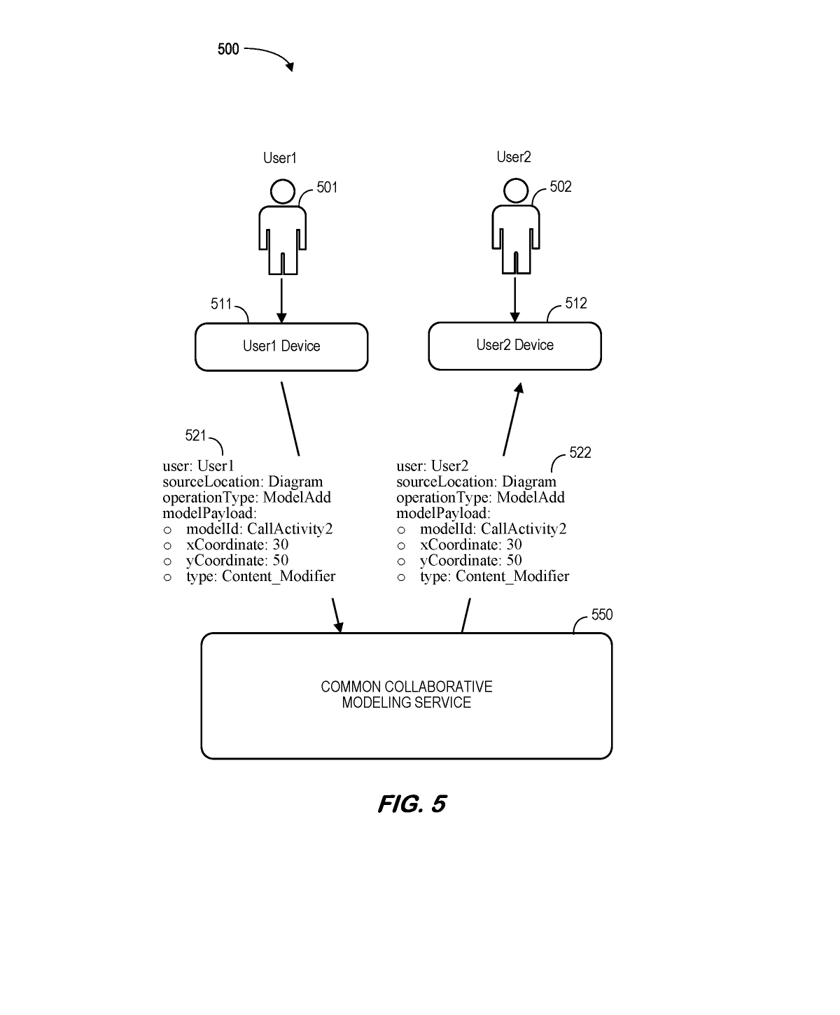

USER1 may then make a change in the modeler (e.g., adding, deleting, or modifying a step, etc.). FIG. 5 is a change and update process 500 in accordance with some embodiments. As before, USER1 501 works with a model on a USER1 device 511 while USER2 502 works with the same model on a USER2 device 512. The devices 511, 512 are clients of a common collaborative modeling service 550. Information about the change 521 is sent by USER device 511 via the WebSocket that was registered with the common collaborative modeling service 550. The common collaborative modeling service 550 can then send information about the change 522 to USER2 after checking the registrations on its service and validating the data format. Similarly, the data might be verified and transmitted to multiple registered clients of the common collaborative modeling service. The information about the change 521, 522 might include, for example, a user identifier, a source location (e.g., where the model is stored), an operation type, a model identifier, coordinates (e.g., where the change was made), a change type, etc.

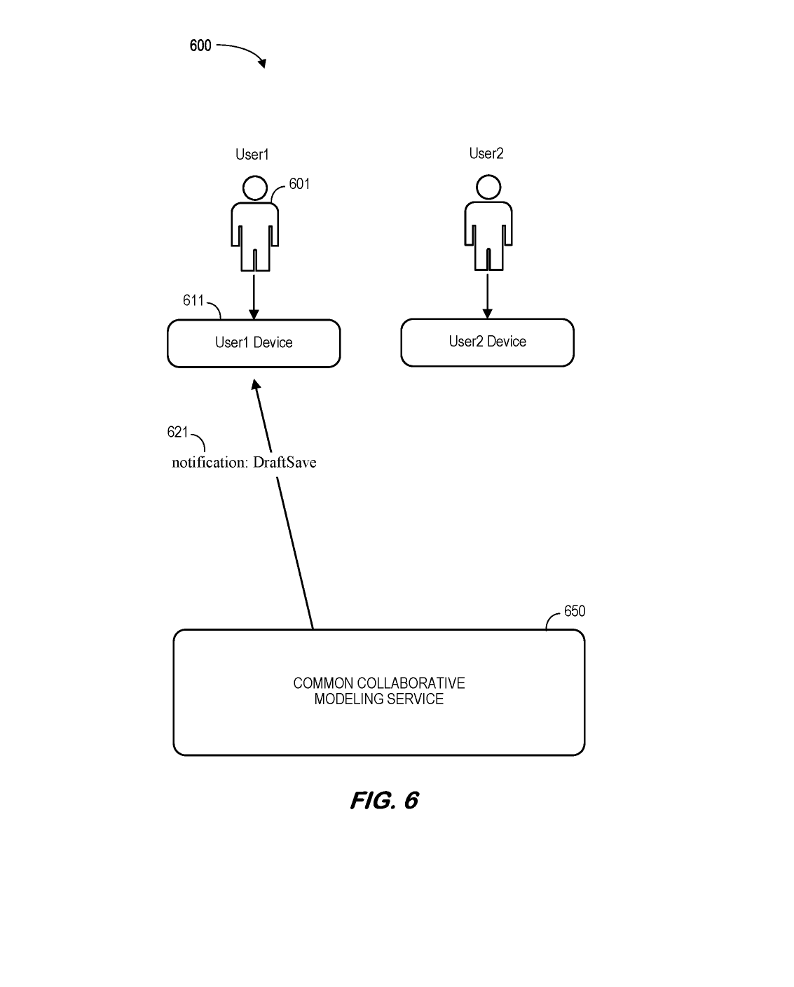

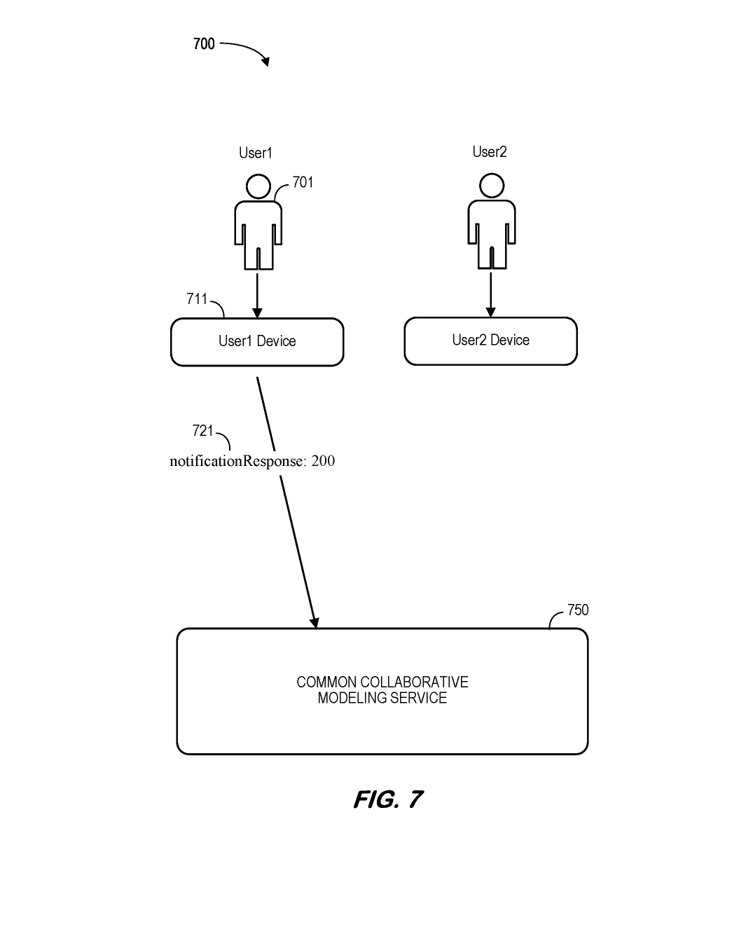

The common collaborative modeling service 550 might then ask a client to persist unsaved data to a local database. For example, it might send a notification to a first registered client and wait for a response. FIG. 6 is a draft save process 600 according to some embodiments. Here, a common collaborative modeling service 650 sends a “DraftSave” notification 621 to a USER1 device 611 associated with USER1 601. The client may then provide a response to the service that the draft save was successful. FIG. 7 is a draft save acknowledgement process 700 in accordance with some embodiments. Here, a USER1 device 711 associated with USER1 701 sends a “NotificationResponse” notification 721 to a common collaborative modeling service 750.

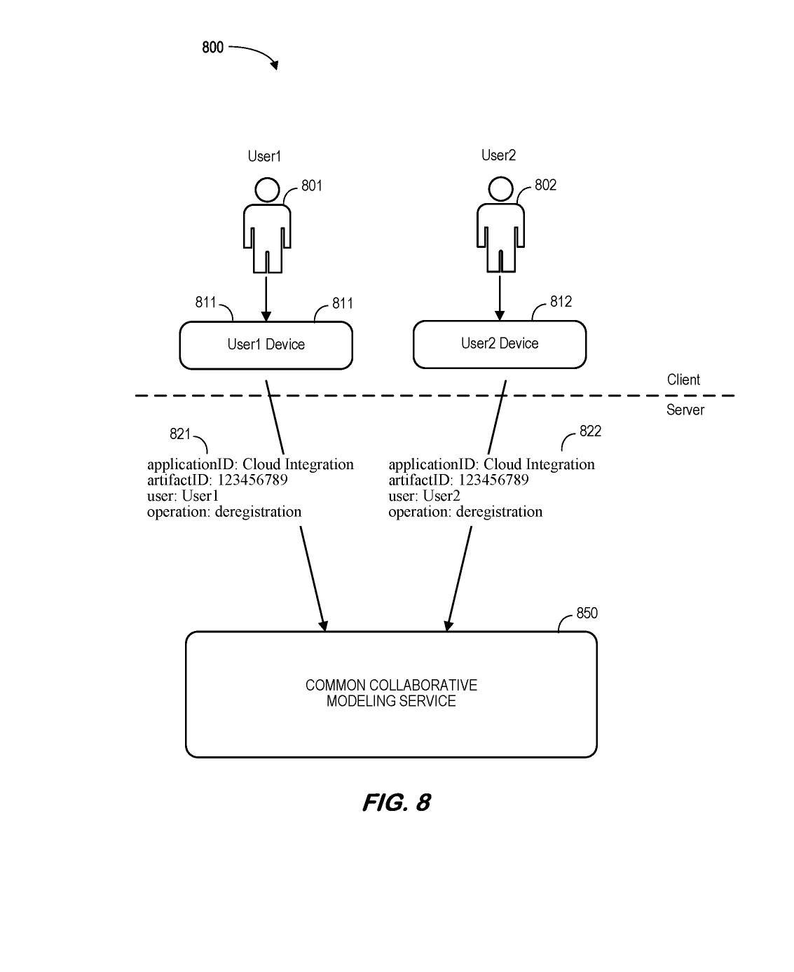

When the collaboration is complete, the clients might register from the service. For example, FIG. 8 is a deregistration process 800 according to some embodiments. As before, USER1 801 worked with a model on a USER1 device 811 while USER2 802 worked with the same model on a USER2 device 812. The devices 811, 812 are clients of a common collaborative modeling service 850. Since the collaboration is complete, the common collaborative modeling service deregisters the clients from the service and ends the WebSocket session. In particular, USER1 and USER2 deregister from the common collaborative modeling service 850 by providing details 821, 822 via WebSockets. The details 821, 822 might include, for example, an application identifier, an artifact identifier, a user identifier, an operation indication (e.g., “deregistration”), etc.

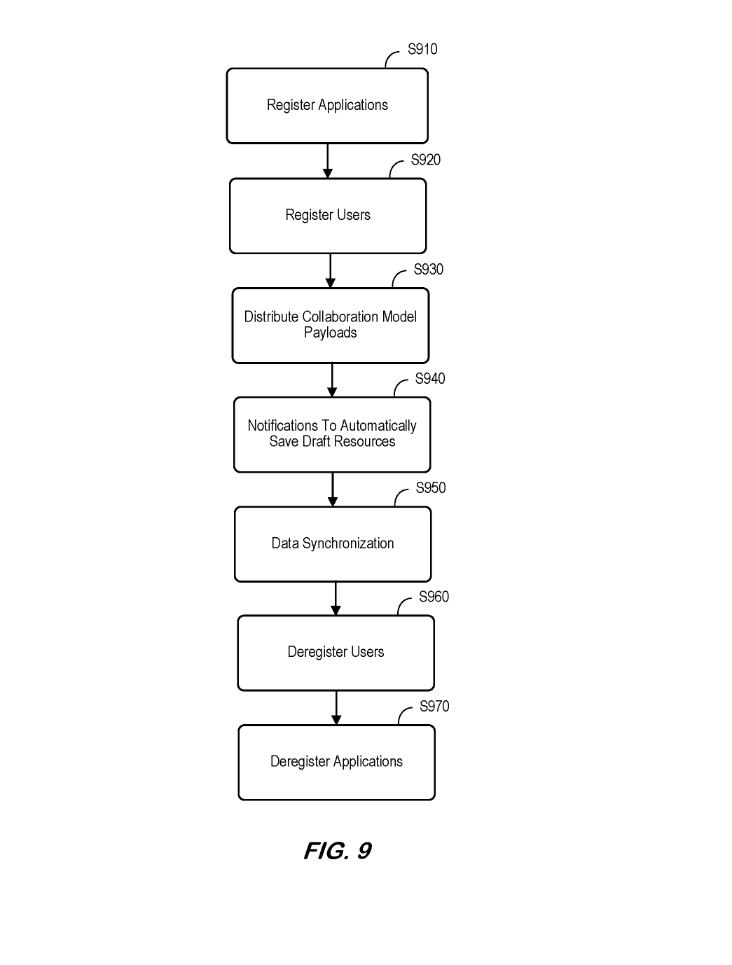

FIG. 9 is a more detailed method from a modeling client’s point-of-view in accordance with some embodiments. At 910, the framework takes care of the registration of applications. Similarly, at 920 the framework takes care of the registration of users. For example, client devices may send registration notifications to a common collaborative modeling service. At 930, collaboration model payloads are distributed. For example, client devices may send and receive updates as changes are made to an integration model. At 940, notifications are provided to automatically save draft resources. For example, clients may receive requests to save workflows from the common collaborative modeling service after pre-determined periods of time. At 950, data synchronization is performed. At 960, the framework arranges for the deregistering of users. Similarly, at 970 the framework handles the deregistering of applications. For example, client devices may send deregistration notifications to the common collaborative modeling service after the model collaboration is complete.

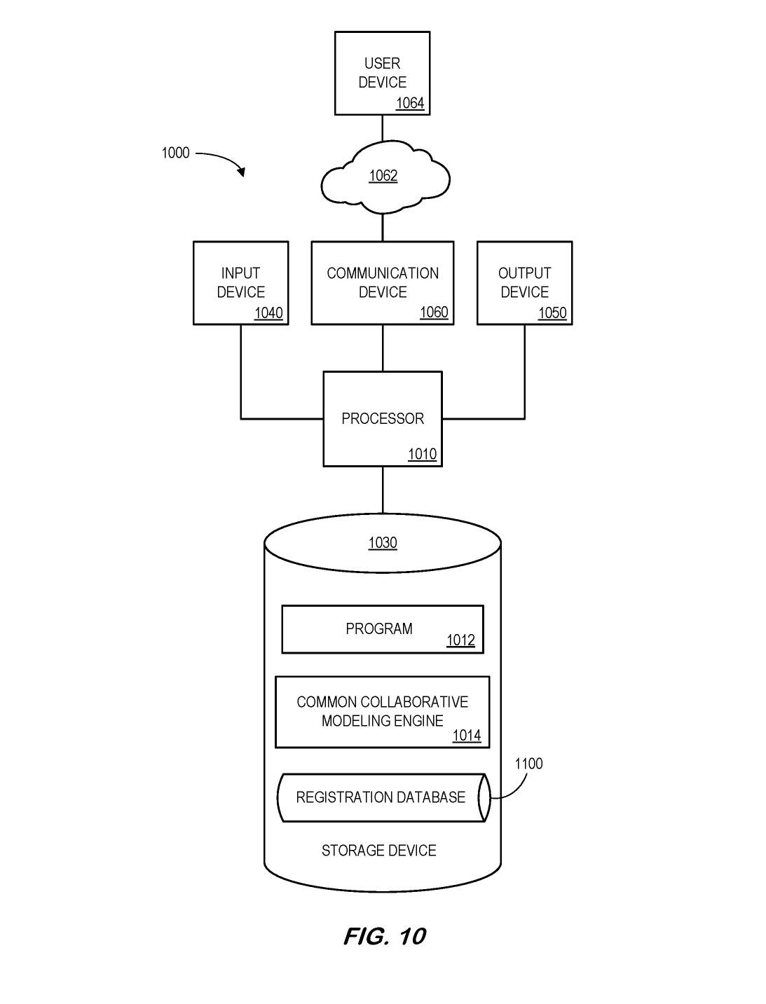

Note that the embodiments described herein may be implemented using any number of different hardware configurations. For example, FIG. 10 is a block diagram of an apparatus or platform 1000 that may be, for example, associated with the framework 100 of FIG. 1 (and/or any other system described herein). The platform 1000 comprises a processor 1010, such as one or more commercially available Central Processing Units (“CPUs”) in the form of one-chip microprocessors, coupled to a communication device 1060 configured to communicate via a communication network 1062. The communication device 1060 may be used to communicate, for example, with one or more user or client devices 1064 via a distributed computer network 1062. The platform 1000 further includes an input device 1040 (e.g., a computer mouse and/or keyboard to input registration information, model updates and saves, etc.) and/an output device 1050 (e.g., a computer monitor to render a display, transmit recommendations, charts, alerts, and/or reports about a collaborative modeling framework or service, etc.).

The processor 1010 also communicates with a storage device 1030. The storage device 1030 may comprise any appropriate information storage device, including combinations of magnetic storage devices (e.g., a hard disk drive), optical storage devices, mobile telephones, and/or semiconductor memory devices. The storage device 1030 stores a program 1012 and/or common collaborative modeling engine 1014 for controlling the processor 1010. The processor 1010 performs instructions of the programs 1012, 1014, and thereby operates in accordance with any of the embodiments described herein. For example, the processor 1010 may receive a first registration request, including a first user identifier and an application identifier, from a first user device. The processor 1010 may also receive a second registration request, including a second user identifier and the application identifier, from a second user device. Based on the received first and second registration requests, information in a common collaborative modeling data store may be updated. A model change message from the first user device may then be received, and, responsive to the received model change message, the processor 1010 may push a model change message to the second user device.

The programs 1012, 1014 may be stored in a compressed, uncompiled and/or encrypted format. The programs 1012, 1014 may furthermore include other program elements, such as an operating system, clipboard application, a database management system, and/or device drivers used by the processor 1010 to interface with peripheral devices.

As used herein, information may be “received” by or “transmitted” to, for example: (i) the platform 1000 from another device; or (ii) a software application or module within the platform 1000 from another software application, module, or any other source.

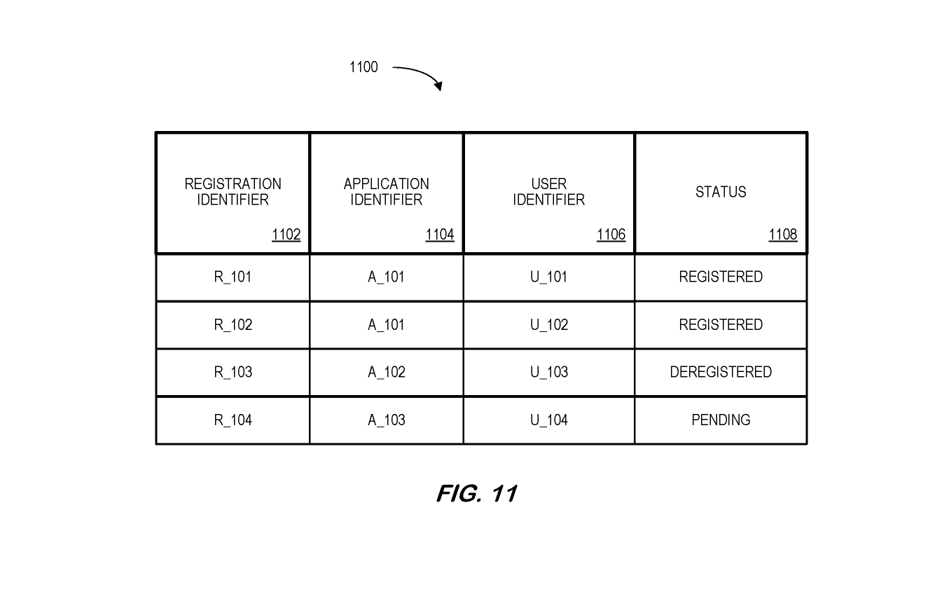

In some embodiments (such as the one shown in FIG. 10), the storage device 1030 further stores a registration database 1100. An example of a database that may be used in connection with the platform 1000 will now be described in detail with respect to FIG. 11. Note that the database described herein is only one example, and additional and/or different information may be stored therein. Moreover, various databases might be split or combined in accordance with any of the embodiments described herein.

Referring to FIG. 11, a table is shown that represents the registration database 1100 that may be stored at the platform 1000 according to some embodiments. The table may include, for example, entries identifying collaborative models on which various users are working. The table may also define fields 1102, 1104, 1106, 1108 for each of the entries. The fields 1102, 1104, 1106, 1108 may, according to some embodiments, specify: a registration identifier 1102, an application identifier 1104, a user identifier 1106, and a status 1108. The registration database 1100 may be created and updated, for example, when a user opens a new collaborative model, adjusts an existing model, etc.

The registration identifier 1102 might be a unique alphanumeric label that is associated with a collaborative modeling request received from a client user. The application identifier 1104 might indicate which modeling application is being used to work on the model in a collaborative way. The user identifier 1106 might indicate the user who asked to work on the collaborative model. The status 1108 might indicate that a request has been registered, deregistered, is currently pending, etc.

In this way, embodiments may let multiple applications hook into a single service instead of building individual collaboration framework. Moreover, the common collaborative modeling can be a generic service offered by a cloud provider (similar to a logging service, a destination service, etc.) that adds substantial value to the service provider offerings.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of modeling applications, any of the embodiments described herein could be applied to other types of collaborative modelling applications.

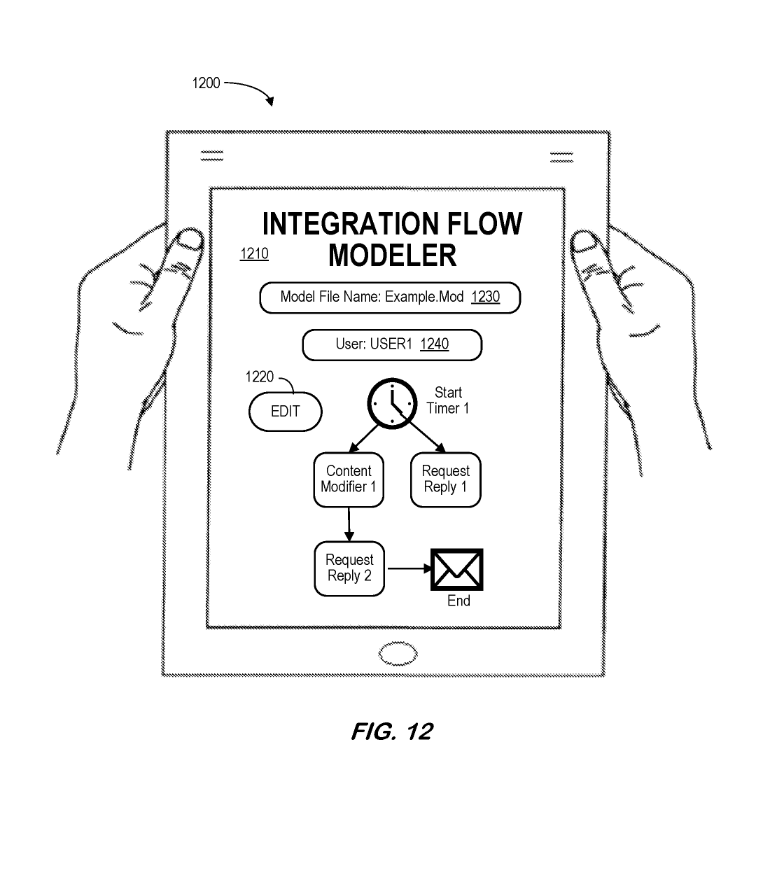

In addition, the displays shown herein are provided only as examples, and any other type of user interface could be implemented. For example, FIG. 12 illustrates a tablet computer 1200 providing model flow display 1210 according to some embodiments. The model flow display 1210 might be used, for example, to collaboratively define or adjust an integration process for an enterprise. A user may interact with the display 1210, such as by touching a model flow step and selecting an “Edit” icon 1220. In this way, a single model 1430 can be simultaneously updated by multiple users 1440.

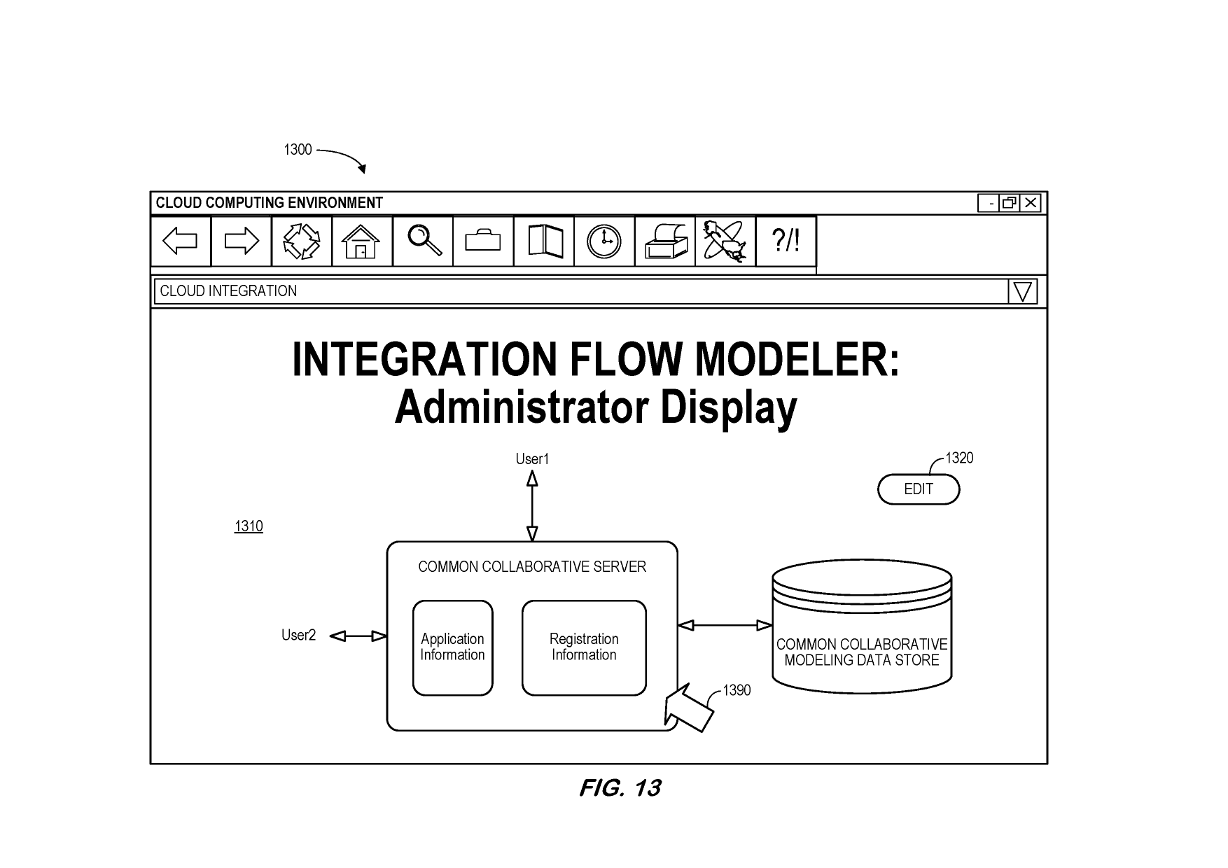

FIG. 13 is an operator or administrator display 1300 in accordance with some embodiments. The display 1300 includes a graphical representation 1310 of a common collaborative framework in accordance with any of the embodiments described herein. Selection of an element on the display 1300 (e.g., via a touchscreen or computer pointer 1390) may result in display of a pop-up window containing more detailed information about that element and/or various options (e.g., to define how a common collaborative server interacts with clients or other elements of a common collaborative modeling framework, etc.). Selection of an “Edit” icon 1320 may also let an operator or administrator adjust the operation of the system (e.g., to change mapping to a data store, adjust registration properties, make changes to validation rules, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system associated with a common collaborative modeling framework in a cloud computing environment, comprising:
a common collaborative modeling data store that contains information about a plurality of collaborative modeling applications, each collaborative modeling application being associated with an integration process; and
a common collaborative server, coupled to the common collaborative modeling data store, including:
a computer processor, and
a computer memory storing instructions that when executed by the computer processor cause the common collaborative server to:
receive a first registration request, including a first user identifier and an application identifier, from a first user device,
receive a second registration request, including a second user identifier and the application identifier, from a second user device,
based on the received first and second registration requests, update information in the common collaborative modeling data store,
receive a model change message from the first user device, and
responsive to the received model change message, push a model change message to the second user device.

2. The system of claim 1, wherein the first registration request further includes at least one of: (i) an artifact identifier, (ii) an operation identifier, and (iii) a draft interval.

3. The system of claim 2, wherein the first registration request is received via a WebSocket.

4. The system of claim 2, wherein the received model change message includes at least one of: (i) the first user identifier, (ii) a source location, (iii) an operation type, (iv) a model identifier, and (v) an application coordinate.

5. The system of claim 2, wherein the common collaborative server is further to verify the model change request from the first user device.

6. The system of claim 2, wherein the common collaborative server is further to ask at least one user device to persist draft save information to a local database in accordance with the draft interval.

7. The system of claim 6, wherein the at least one user device replies with an indication that the draft save information has been successfully persisted in the local database.

8. The system of claim 1, wherein the common collaborative server is further to receive a deregistration request from the first user device.

9. The system of claim 1, wherein the common collaborative server is implemented in the cloud computing environment via a microservice architecture.

10. A computer-implemented method associated with a common collaborative modeling framework in a cloud computing environment, comprising:
transmitting, from a computer processor of a first user device executing a first collaborative modeling application, a first registration request including a first user identifier and an application identifier to a common collaborative server;
transmitting a model change message from the first user device to the common collaborative server; and
receiving information about another model change message from a second user device.

11. The method of claim 10, wherein the first registration request further includes at least one of: (i) an artifact identifier, (ii) an operation identifier, and (iii) a draft interval.

12. The method of claim 11, wherein the first registration request is transmitted via a WebSocket.

13. The method of claim 11, wherein the received model change message includes at least one of: (i) the first user identifier, (ii) a source location, (iii) an operation type, (iv) a model identifier, and (v) an application coordinate.

14. The method of claim 11, wherein the common collaborative server is further to verify the model change request from the first user device.

15. The method of claim 11, further comprising:
receiving, at the first user device from the common collaborative server, a request to persist draft save information to a local database in accordance with the draft interval.

16. The method of claim 15, further comprising:
replying to the common collaborative server with an indication that the draft save information has been successfully persisted in the local database.

17. The method of claim 10, further comprising:
transmitting a deregistration request to the common collaborative server.

18. One or more non-transitory computer-readable media storing computer-executable instructions that, when executed by a computing system, cause the computing system to perform operations for a common collaborative modeling framework in a cloud computing environment, comprising:
receiving, at a computer processor of a common collaborative server, a first registration request, including a first user identifier and an application identifier, from a first user device;
receiving a second registration request, including a second user identifier and the application identifier, from a second user device;
based on the received first and second registration requests, updating information in a common collaborative modeling data store, wherein the common collaborative modeling data store contains information about a plurality of collaborative modeling applications, each collaborative modeling application being associated with an integration process;
receiving a model change message from the first user device; and
responsive to the received model change message, pushing a model change message to the second user device.

19. The media of claim 18, wherein the common collaborative server is implemented in the cloud computing environment via a microservice architecture.

20. The media of claim 18, wherein the first registration request further includes at least one of: (i) an artifact identifier, (ii) an operation identifier, and (iii) a draft interval.
